(19) United States
(12) Patent Application Publication
(10) Pub. No.: US 2018/0186670 A1
(43) Pub. Date: Jul. 5, 2018

(54) FLUID TREATMENT APPARATUS AND PROCESSES

(71) Applicants: Richard PHILPOTT, Elsworth Cambridge (GB); Naresh MAHAMUNI, Nevada City, NV (US); Jason Everest FISCHER, Nevada City, NV (US); CHELAN, INC., Dover, DE (US); Yuri PISHCHALNIKOV, Grass Valley, CA (US)

(72) Inventors: Richard William PHILPOTT, Cambridge (GB); Naresh MAHAMUNI, Nevada City, NV (US); Yuri PISHCHALNIKOV, Grass Valley, CA (US); Jason Everest FISCHER, Nevada City, NV (US)

(73) Assignee: Chelan, Inc., Dover, DE (US)

(21) Appl. No.: 15/548,422

(22) PCT Filed: Feb. 3, 2016
(86) PCT No.: PCT/US16/16470

§ 371 Date: Aug. 3, 2017

Related U.S. Application Data
(60) Provisional application No. 62/111,660, filed on Feb. 3, 2015.

(51) Int. Cl. C02F 9/00; B02C 19/18; B02C 23/12

(52) U.S. Cl. CPC C02F 9/00; C02F 2101/12; B02C 23/12; B02C 19/18

(57) ABSTRACT

A fluid treatment apparatus is described. The fluid treatment apparatus includes: (i) a pulverizer designed to pulverize solids present in a fluid flow to produce pulverized solids admixed with the fluid flow; (ii) a rotatable shaft for rotating the pulverized solids and the fluid flow; (iii) a restrictor or filter for retaining a first portion of the pulverized solids, and allowing a second portion of pulverized solids and a second portion of the fluid flow to pass therethrough; and (iv) a first recirculating line configured to receive the first portion of the pulverized solids and a first portion of the fluid flow that did not pass through the restrictor or the filter.

### RELATED APPLICATION

The application claims priority from U.S. Provisional Application having Ser. No. 62/111,660, filed on Feb. 3, 2015, which is incorporated herein by reference for all purposes.

### FIELD OF THE INVENTION

The present teachings generally relate to fluid treatment apparatuses and processes relating thereto. More particularly, the present invention relates to fluid treatment apparatuses and processes using recirculation and tangential filtration.

### BACKGROUND OF THE INVENTION

Industrial and municipal entities incur substantial costs in the operation of fluid treatment facilities (i.e. a waste water treatment facility). The fluid treatment apparatuses and processes within these facilities remove solid pollutants (hereinafter referred to as “solids”) from a high-volume fluid flow, which may contain a mixture of fluids and/or solids. By way of example, fluid treatment facilities may implement a filtering apparatus to catch or trap solids as the fluid flows through the filter. Conventional filters, however, can easily become clogged by the trapped solids and must be cleaned or replaced regularly to maintain a high-volume fluid flow through the filter. To maintain the high-volume fluid flow, redundant fluid treatment apparatuses may be needed to divert the fluid flow while a filter is cleaned or replaced, or the fluid treatment apparatus must be shut down while the filter is cleaned or replaced. The redundant fluid treatment apparatuses or the downtime to replace or clean a filter increases the capital and/or operating costs for fluid treatment facilities.

### SUMMARY OF THE INVENTION

What is needed, therefore, are fluid treatment apparatus and processes that separate solids from, preferably, a high-volume fluid flow in a cost effective manner. In one aspect, the present arrangements provide a fluid treatment apparatus. The fluid treatment apparatus includes: (i) a pulverizer designed to pulverize solids present in a fluid flow to produce pulverized solids admixed with the fluid flow; (ii) a rotatable shaft for rotating the pulverized solids and the fluid flow; (iii) a restrictor or filter for retaining a first portion of the pulverized solids, and allowing a second portion of pulverized solids and a second portion of the fluid flow to pass therethrough;

and (iv) a first recirculating line configured to receive the first portion of the pulverized solids and a first portion of the fluid flow that did not pass through the restrictor or the filter. In certain embodiments of the present arrangements, the first recirculating line further comprises a first recirculating line inlet and a first recirculating line outlet, and wherein the first recirculating line inlet is located upstream from the restrictor or the filter and the first recirculating line outlet is located upstream from the pulverizer.

In one embodiment of the present arrangements, the fluid treatment apparatus further includes a housing for enclosing the pulverizer, the rotatable shaft and the restrictor or the filter, and the first circulating line inlet is an aperture defined in the housing. Further, the first recirculating line outlet may extend into the housing and is located proximate the pulverizer. In other embodiments of the present arrangement, the housing is designed to be coupled to or for housing the first recirculating line.

In another embodiment of the present arrangements, the pulverizer includes a cavitation apparatus that effects cavitation. Preferably, the cavitation apparatus includes a rotor and a stator that act on the mixture to pulverize the solids and effect cavitation.

In accordance with one preferred embodiment of the present arrangements, the fluid flow towards the pulverizer is in an axial direction such that an axis of the axial direction extends along a length of the fluid treatment apparatus. In this embodiment, the rotatable shaft is capable of rotating around the axis to redirect motion of some of the fluid flow and some of the pulverized solids in a radial direction that is at an angle from the axial direction. In certain of the preferred embodiments, some of the pulverized solids redirected in the radial direction have an average particle size that is greater than that of the second portion of the pulverized solids that pass through the restrictor or the filter.

In another implementation of the present arrangements, the second portion of the pulverized solids have an average diameter that ranges from about 1 μm to about 10 mm. In certain embodiments, the restrictor or the filter is stationary or rotates. The restrictor or the filter may rotate in a same direction as a rotational direction of the rotor, or rotates in an opposite direction of the rotation direction of the rotor. In another embodiment of the present arrangements, the restrictor or the filter is cone-shaped and an apex of the cone points towards the pulverizer.

In yet another embodiment of the present arrangements, the fluid treatment apparatus further comprises a second recirculating line configured to receive some portion of the second portion of pulverized solids and some portion of the second portion of the fluid flow. The second recirculating line further comprises a second recirculating line inlet and a second recirculating line outlet, and wherein the second recirculating line inlet is located downstream from the restrictor or the filter and the second recirculating line outlet is located upstream from the pulverizer.

In another aspect, the present arrangements provide a fluid treatment system. The fluid treatment system includes: (i) a fluid treatment apparatus for receiving a fluid flow and then pulverizing and filtering a portion of solids present in the fluid flow to provide a solid filtrate; and (ii) a fluid filtrate and a separator for separating the solid filtrate from the fluid filtrate to produce a treated fluid. The separator may include at least one member chosen from a group comprising centrifuge, ultrasonic cleaner, settling tank, magnetic separator, dead-end filter, chromatographic separator including ion-exchange chromatography, venturi, acoustic driver, gas injection port, electrolytic separator, coagulator, flocculation device and air flotation device.

In yet another aspect, the present teachings provide a method of treating a fluid. The fluid treatment method includes: (i) pulverizing solids present in a fluid flow at an upstream location to produce pulverized solids in the fluid flow, wherein motion of the fluid flow is in a first direction; (ii) displacing, in a second direction and towards a predetermined location, some of the pulverized solids and some of the fluid flow, and wherein the second direction is not the same as the first direction; (iii) retaining a first portion of the pulverized solids and a first portion of the fluid flow; (iv) conveying to a downstream location, a second portion of the pulverized solids and a second portion of the fluid flow, and wherein the downstream location is downstream from the upstream location; and (v) recirculating, from the predetermined location to the upstream location, the first portion of the pulverized solids and the first portion of the fluid flow for pulverizing. In certain embodiments of the present teachings, the upstream location is a location prior to a pulverizer, wherein the predetermined location is at or proximate a recirculating line inlet that receives the first portion of the pulverized solids and the first portion of the fluid flow, and wherein the downstream location is located downstream from a filter or a restrictor.

The above-mentioned treatment method further includes mixing the first portion of the pulverized solids and the first portion of the fluid flow with an incoming fluid flow that includes incoming solids. In another embodiment of the present teachings, the step of pulverizing includes performing acoustic cavitation or performing hydrodynamic cavitation.

In another embodiment of the present teaching, the fluid treatment method further includes introducing an adsorbent to remove dissolved solids from the fluid flow by adsorption. The adsorbent may be a material chosen from a group comprising carbon, clay, soil, bituminous coal, montmorillonite, chitosan, fly ash, alumina, bentonite, zeolite, β-cyclodextrin, dead mushrooms, silica gel, diatomaceous earth, ion exchange resins, SP206, and polyethylene.

The construction and method of operation of the invention, however, together with additional objects and advantages thereof, will be best understood from the following descriptions of specific embodiments when read in connection with the accompanying figures.

### BRIEF DESCRIPTION OF THE DRAWINGS

FIG. 1 shows a side-sectional view of a fluid treatment apparatus, according to one embodiment of the present arrangements, for high throughput fluid treatment and that includes a first recirculating line.

FIG. 2 shows a side-sectional view of a fluid treatment apparatus, according to another embodiment of the present arrangements, for high throughput fluid treatment and that includes a first and second recirculating line.

FIG. 3 shows a side-sectional view of a fluid treatment system, according to one embodiment of the present arrangements, and that incorporates one or more fluid treatment apparatus of FIG. 1 and a separator.

FIG. 4 shows a process flow diagram for a fluid treatment process, according to one embodiment of the present teachings, that shows the major steps involved in fluid treatment.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention may be practiced without limitation to some or all of these specific details. In other instances, well-known process steps have not been described in detail in order to not unnecessarily obscure the invention.

The present teachings recognize that conventional wastewater treatment techniques, such as activated sludge process or anaerobic digestion techniques, are unsuitable for the removal of harmful micro-pollutants, which may, for example, be toxic to microorganisms. By way of example, conventional wastewater treatment techniques such as adsorption, UV, UV/H₂O₂, ozonation, electrochemical oxidation, ultrasound, fenton oxidation, air stripping (individually or in combination) are used to mitigate the toxic micro-pollutants. These conventional treatment techniques, however, do not effectively remove harmful pollutants in a fluid flow.

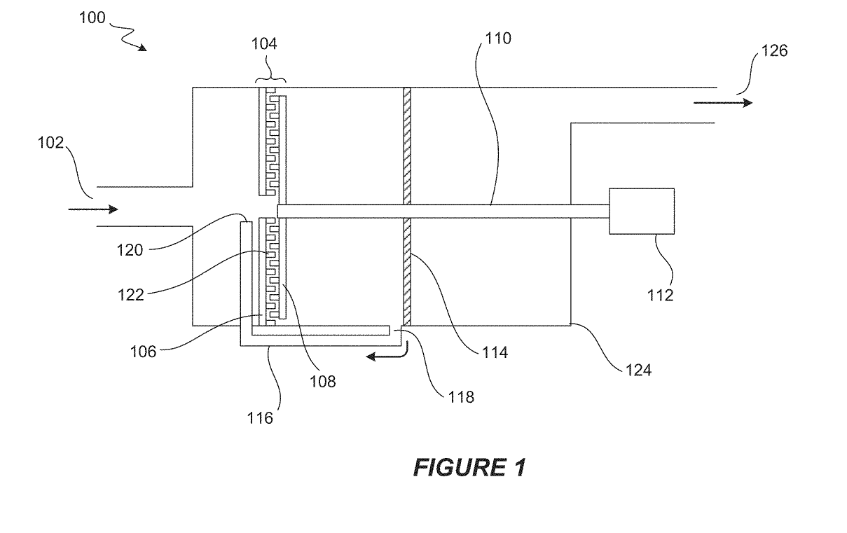

The present teachings provide improved systems and methods for optimizing treatment of a fluid flow containing pollutants in a dissolved (e.g., molecules or in ionic form) and/or solid (i.e., not dissolved) state. In connection with treatment of fluid flow that contains dissolved contaminants, preferred embodiments of the present teachings use adsorbents for removal of the dissolved contaminants. In these embodiments, the dissolved contaminants bind, in a binding zone, with the adsorbents to form a solid complex, which is removed downstream from the binding zone or in a subsequent step after effecting binding. Moreover, these embodiments provide one or more features that enhance the binding ability of the adsorbent (with dissolved contaminants) by re-circulating the solid complex through a surface-area enhancing zone (e.g., a zone that includes a pulverizer 104 of FIG. 1 and/or a zone that effects acoustic or hydrodynamic cavitation). The adsorbent and/or the solid complex exiting the surface-area enhancing zone having a larger exposed surface area and a greater number of binding sites.

In connection with the treatment of solids (not dissolved contaminants) in the fluid flow, the surface-area enhancing zone of the present teachings reduces the size of the solid contaminant to small enough dimensions, so that they pass through a filter and are removed downstream by a solids separator. In more preferred embodiments of the present teachings, hydrodynamic cavitation and/or acoustic cavitation effectively reduce the size of the solid contaminant.

As a result, in certain embodiment of the present teachings, cavitation and adsorption may be used together to process large, industrial scale volume streams. In the context of high throughput processing of fluid flow, the present teachings coin the term “cavisorption” to describe the combination of cavitation and adsorption. As will be explained below, in one present arrangement, intense cavitation, i.e., implosion of the cavitation bubbles, produces nascent active surfaces on the adsorbent's surface to thereby enhance adsorption of the dissolved contaminant on the adsorbent's surface. Representative applications of the present invention include, but are not limited to, fracking water treatment, ground water treatment, wastewater disinfection, industrial contaminated water, and sludge digestion.

FIG. 1 shows a fluid treatment apparatus 100, according to one embodiment of the present arrangements, for treating a fluid flow that includes a mixture of a fluid and solids. The solids may include one or more members chosen from a group comprising dissolved contaminants, solids (not dissolved contaminants) and added solids (e.g., adsorbents). In this embodiment, fluid treatment apparatus 100 includes a housing 124 that is fitted with a housing inlet 102 and a housing outlet 126. As shown in FIG. 1, housing inlet 102 introduces a fluid flow, which includes solids, i.e., dissolved contaminants and solid (not dissolved) contaminants, to a housing 124 for processing or treatment of the fluid. The treated effluent stream is dispensed from housing outlet 126. In certain embodiments of the present teachings, adsorbents are introduced inside housing 124 from a separate inlet and/or housing inlet 102.

Housing 124 includes a pulverizer 104, a rotatable shaft 110, a restrictor or filter 114, and a first recirculating line 116. Pulverizer 104 pulverizes and reduces the size of the solids, e.g., adsorbents and/or solid (not dissolved) contaminants, in a fluid flow to create pulverized solids that are admixed with the fluid flow. Rotatable shaft 110 rotates the pulverized solids along with the fluid flow, propelling the fluid and pulverized solids radially outwards and away from shaft 110 towards the sidewalls of housing 124. In other words, rotatable shaft 110 redirects fluid and pulverized solids to move away from an axial direction (which is along a length of housing 124) towards a radial direction (towards the sidewalls of housing 124).

Restrictor or filter 114 catches or traps a first portion of the pulverized solids (hereinafter referred to as the “solid residue”). Along with the solid residue, a first portion of fluid (hereinafter referred to as the “fluid residue”) radially flows such that it does not pass through restrictor or filter 114. First recirculating line 116 is configured to recirculate the solid and the fluid residues a location that is upstream from pulverizer 104. Specifically, a recirculation inlet 118 is disposed upstream from restrictor or filter 114 and is located proximate a transition from of housing 114 and recirculation line 116. Rotational motion of fluid being introduced at first recirculating line inlet 118 causes it to be at a higher pressure than the fluid exiting from a first recirculating line outlet 120. This pressure differential transports the solid and the fluid residues through recirculation line 116 to a location that is situated upstream from pulverizer 104. At this location, the solids and the fluid residue (“admixed solid/liquid residue”) are mixed with an incoming fluid flow that includes incoming solids. Admixed solid/liquid residue and incoming stream mixture (including incoming solids) is disposed downstream and proximate to housing inlet 102. In preferred embodiments of the present arrangements, the mixture of admixed solid/liquid residue and the incoming stream is formed proximate pulverizer 104. As FIG. 1 shows, the mixture of admixed solid/liquid residue and the incoming stream undergoes processing at pulverizer 104 in a manner similar to the processing of the previous fluid stream.

A second portion of fluid (hereinafter referred to as the “fluid filtrate”) and a second portion of the solids (hereinafter referred to as the “solid filtrate”) pass through restrictor or filter 114 for further processing. In other embodiments of the present arrangement, one or more additional fluid treatment apparatuses are disposed for effective serial fluid treatment in different stages.

Pulverizer 104 includes any structure capable of breaking solids into smaller particles. In one embodiment of the present arrangements, pulverizer 104 includes a rotating rotor 108 and a stationary stator 106. Motor 112 may rotate shaft 110 at an appropriate speed to displace the solids and fluid flow impinging upon it. In the embodiments where a rotor 108 is used, motor 112 may also be used to rotate rotor 108. The size of motor 112 may depend on various factors, e.g., whether it is being used to rotate shaft 110 and/or rotor 108, the required rotational velocities the motor should effect and size of fluid treatment apparatus 100. By way of example, shaft 110 and rotor 108 having an 11-inch (279.4 mm) diameter allow rotational speeds of shaft 110 and rotor 108 to range from about 50 rotations per minute (“rpms”) to about 20,000 rpms. In a preferred embodiment of the present arrangements, each of shaft 110 and rotor 108 rotate at a speed that ranges from about 1,500 rpms to about 6,000 rpms. In a more preferred embodiment of the present arrangements, each of shaft 110 and rotor 108 rotate at a speed that ranges from about 2,000 rpm to about 5,500 rpm.

Although FIG. 1 shows rotor 108 downstream from stator 10, other present arrangements are not so limited. In one embodiment of the present arrangements, fluid treatment apparatus 100 may include a reverse orientation where rotor 108 is upstream from stator 106. In another embodiment, rotor 108, having pulverizing features on its upstream surface and downstream surface, may be sandwiched between two stators 106. In yet another embodiment of the present arrangements, stator 106, having pulverizing features on its upstream and downstream surfaces, may be sandwiched between two rotors 108. In yet another embodiment of the present arrangements, fluid treatment apparatus 100 may use multiple sets of rotor 108 and stator 106 upstream from restrictor or filter 114. In yet another embodiment of the present arrangements, stator 106 is not stationary and may rotate. By way of example, in one present arrangement, stator 106 rotates in the same direction as rotor 108, and in another present arrangement, stator 106 rotates in an opposite direction as rotor 108.

Rotor 108 and stator 106 may include one or more pulverizing features (e.g., pins, blades, venturi vanes, or knives) for pulverizing solids. In the embodiment shown in FIG. 1, rotor 108 and stator 106 include one are more pulverizing pins 122, which may be any appropriate geometry, length, number, and orientation or arrangement. As the mixture of fluid and solids pass between the pulverizing pins 122 of rotor 108 and stator 106, the fluid and solids are agitated, which causes the solids to physically break apart into smaller particles.

In addition to pulverizing solids, pulverizer 104 may also effect cavitation (e.g., hydrodynamic and/or acoustic cavitation). By way of example, hydrodynamic cavitation occurs when the pressure in the fluid stream decreases below vapor pressure, causing formation and growth of gas and/or vapor bubbles. An increase in pressure causes the bubbles to collapse, immediately releasing high local temperatures and pressures that formed inside the collapsing bubbles. The high temperatures and pressures may cause additional separation, milling and/or activation of solids and the activation of radicals, which may effect chemical reactions and/or kill organisms such as bacteria or viruses.

Housing 124, which includes housing inlet 102 and housing outlet 126, houses at least part of pulverizer 104, rotatable shaft 110, and restrictor or filter 114. Furthermore, housing 124 may be coupled to or may house first recirculating line 116. As shown in FIG. 1, housing 124 also houses stator 106 and rotor 108, which may rotate within housing 124. Preferably, housing 124 provides access to stator 106, rotor 108, rotatable shaft 110 and restrictor or filter 114. For cleaning and maintenance, housing 124 may also allow access for removal of such components from fluid treatment apparatus 100. Furthermore, restrictor or filter 114 may be changed to meet the applications requirement of different treatment processes. In certain present arrangements, a single restrictor or filter 114 may be used inside fluid treatment apparatus 100 for carrying out different fluid treatment applications.

Restrictor or filter 114 comprises any appropriate structure that separates the solid and the fluid residues from the solid and the fluid filtrates. In one embodiment, restrictor or filter 114 of the present arrangements is a disc having multiple apertures defined therein to allow fluid flow through the apertures. The size of the solids, within the fluid, that can pass through the apertures of restrictor or filter 114 may be modified depending on the fluid treatment needs. By way of example, restrictor or filter 114 may restrict particle sizes ranging from about 1 μm to about 10 mm.

In another embodiment of the present arrangement, restrictor or filter 114 includes a filtration material (e.g., a membrane mesh or cloth material). In this embodiment, the filtration material is positioned upstream from and adjacent to a support structure having multiple apertures defined therein. By way of example, filtration material is composed of an appropriate mesh material that provides the requisite filtering characteristics, but that may not be able to structurally support itself due to the high pressures encountered during operation of fluid treatment apparatus 100. To this end, the support structure supports the filtration material. Moreover, apertures defined on the support structure surface serve as conduits through which the solid and the fluid filtrates flow. In this configuration, however, filtration material alone may filter the pulverized solids present in the fluid flow. In preferred aspects of the present arrangements, filtration material is easily and quickly removed or replaced with a different or the same filtration material, depending on the application.

Restrictor or filter 114 is of an appropriate shape to effect filtration. In one preferred embodiment, restrictor or filter 114 of the present arrangements is cone-shaped, with the cone apex pointing towards pulverizer 104. In this configuration and design, an exposed surface area of restrictor or filter 114 available for filtering solids is increased. During operation of fluid treatment apparatus 100, larger particles that do not pass through restrictor or filter 114 are conveyed to first recirculating line 116 along the cone shaped surface. The smaller particles pass through restrictor or filter 114 and may undergo additional processing if needed. In other embodiments, restrictor or filter 114 of the present arrangements is of other shapes, such as curves, pleats, or crenelated structures. Like a cone-shaped structure, these shapes may be similarly used to increase surface area of restrictor or filter 114, which ultimately increases the efficiency of restrictor or filter 114.

Restrictor or filter 114 may be either stationary or may rotate. If restrictor or filter 114 rotates, it may do so in the same direction or in the opposite direction as rotor 108. As described above, a rotating feature (e.g., rotor 108), coupled to rotatable shaft 110, forces some of the fluid and pulverized solids outward, towards the interior sidewalls of housing 124. While wishing to not be bound by theory, the present teachings recognize that a linear centrifugal force is given by the expression m*r*ω², where m is the mass of the fluid particle, r is the radial distance from the center of the rotating feature (e.g., rotor center) to the fluid “particle” (a fluid volume sufficiently small to be considered as one piece), and ω=2πn/60 is the angular velocity, where n is the rotational speed having units of rpms. Thus, the centrifugal force is proportional to a distance the fluid particle has traversed from the center of the rotating feature to the sidewalls of housing 124. In other words, the centrifugal force increases as the fluid moves away from the center of the rotating feature and towards the periphery (i.e., where the boundary is defined by sidewalls of housing 124).

Particularly, the centrifugal force of the rotating feature pushes the larger or denser solids farther, than the smaller or lighter solids, towards sidewalls of housing 124. Thus, a tangential fluid flow across the surface of restrictor or filter 114 from a rotating center (e.g., at or near shaft 110) towards sidewalls of housing 124 is advantageous for many reasons. By way of example, such tangential flow has a sweeping effect near, and in certain instances parallel to, the surface of restrictor or filter 114 which pushes larger or denser solid particles towards the interior sidewall of housing 124. As another example, such tangential flow prevents larger solids from blocking fluid flow through restrictor or filter 114. As a result, smaller solids relatively easily pass through restrictor or filter 114. Thus, the present teachings provide systems and methods that allow smaller solids to pass through restrictor or filter 114 and effectively remove larger solids through tangential flow, are performing “tangential filtration.” In another embodiment, the present arrangements use a counter-rotating component as a restrictor or filter 114 that enhances tangential flow by increasing a relative velocity of fluid flow over restrictor or filter 114.

Tangential filtration of the present teachings provides improved efficiencies over conventional water treatment systems. During operation of conventional fluid treatment systems, when a restrictor or filter is clogged by larger solid particles, there are fewer pathways for the fluid and smaller particle solids to pass through the restrictor or filter. In other words, surface area through which the fluid may pass through is reduced. Thus, to maintain a continuous volumetric flow rate, a fluid treatment system will need to increase the velocity of the fluid. By way of example, a velocity-inducing component (e.g., a pump) must increase the velocity of fluid to maintain the volumetric flow rate. The pump uses additional energy, which reduces the energy efficiency of the conventional fluid treatment system. The tangential filtration of the present arrangements, however, prevents or reduces the number of larger particles from clogging restrictor or filter 114. Thus, there are more pathways through which fluid may flow. As a result, less energy is required to maintain a constant volumetric flow rate through fluid treatment apparatus 100.

Tangential filtration of the present teachings also has the benefit of reducing the frequency in which the fluid treatment apparatus 100 is shut down to replace or de-clog a filter. In conventional fluid treatment systems, the system may be shut down frequently to clean or replace the filter. In other conventional systems, the fluid flow may need to be reversed to de-clog and remove the large particles from the restrictor or filter. In either embodiment, the conventional fluid treatment system must stop filtering fluid at regular intervals to remove particles clogging the restrictor or filter. The present arrangements, however, provide fluid treatment apparatuses that reduce the amount of solids that block the fluid flow through restrictor or filter 114. As a result, fluid treatment apparatus 100 is operational for a longer period of time without ceasing operation over conventional fluid treatment systems.

In other aspects of the present arrangements, an ultrasonic cleaning apparatus may be used, in combination with restrictor or filter 114, to aid in the removal of obstructed solids. Ultrasonic energy may be applied to restrictor or filter 114 at a predetermined interval or by automation, for example, by utilizing a feedback signal from a turbidity or flow meter sensor disposed inside first recirculating line 116. In another embodiment, one or more nozzles of the present arrangements direct high-velocity fluid streams at restrictor or filter 114 to remove obstructed solids.

The fluid and pulverized solids forced through pulverizer 104 and/or rotatable shaft 110 create a relatively high downstream pressure compared to a lower pressure upstream from pulverizer 104. This pressure differential and rotation of shaft 110 forces the residual solids and fluid flow into first recirculating line 116 and back through pulverizer 104. Thus, solids that are too large to pass through restrictor or filter 114 are pulverized again to reduce the size of the solids. Furthermore, first recirculating line 116 prevents solids from accumulating and clogging restrictor or filter 114 by removing the residual solids that did not pass through restrictor or filter 114. Consequently, the presence of first recirculating line 116 allows the filtrate solids and fluid to effectively pass through restrictor or filter 114. Preferably, first recirculating line 116 has an internal diameter that ranges from about 5 mm to about 50 mm.

First recirculating line 116 may include a monitoring apparatus (e.g., one or more turbidity sensors) to analyze the first portion of fluid and the first portion of the solids in first recirculating line 116 to control the recirculation flow, to determine when restrictor or filter 114 is clogged or to optimize fluid treatment apparatus 100 for a particular solid size. First recirculating line 116 may also include additional filtering devices (e.g., an in-line centrifuge) to provide additional solids removal. Similarly, fluid treatment apparatus 100 may utilize permanent magnets in certain component or locations (e.g., first recirculating line 116) to remove ferromagnetic or paramagnetic particles from the fluid stream. In another embodiment, first recirculating line 116 includes a pump (e.g., a screw or peristaltic pump) to aid in recirculating residual fluid. In certain embodiments, reducing the pressure at recirculating line output 120 may increase the pressure differential. By way of example, increasing the bulk flow speed near recirculating line output 120 using a constriction or a venturi may increase the pressure differential. In another embodiment, recirculating line inlet 118 includes a catching mechanism or “scoop” to collect and convey the residual solids to first recirculating line 116.

While FIG. 1 shows fluid treatment system 100 according to one embodiment of the present arrangements, additional embodiments are contemplated. By way of example, according to another embodiment, fluid treatment apparatus 100 may include additional restrictors or filters, downstream from restrictor or filter 114, each including a first recirculating line 116 back to a lower pressure zone that is located upstream from pulverizer 104. In one embodiment of the present arrangements, each restrictor or filter downstream from restrictor or filter 114 progressively restricts smaller particle sizes. As a result, each restrictor or filter is not clogged with larger particles that constrain fluid flow. Instead, the upstream restrictor or filter filters the larger particles and directs them, through a recirculating line, to pulverizer 104. In another embodiment, to treat high volume of fluid flows, multiple fluid treatment apparatuses 100 may be installed in succession to remove and/or reduce a selection of solids. As the fluid flows through each fluid treatment apparatus 100, each downstream fluid treatment apparatus 100 breaks down additional solids in the fluid. In other words, each pulverizer 104, restrictor or filter 114 and first recirculating line 116 reduces the particle size of the solids.

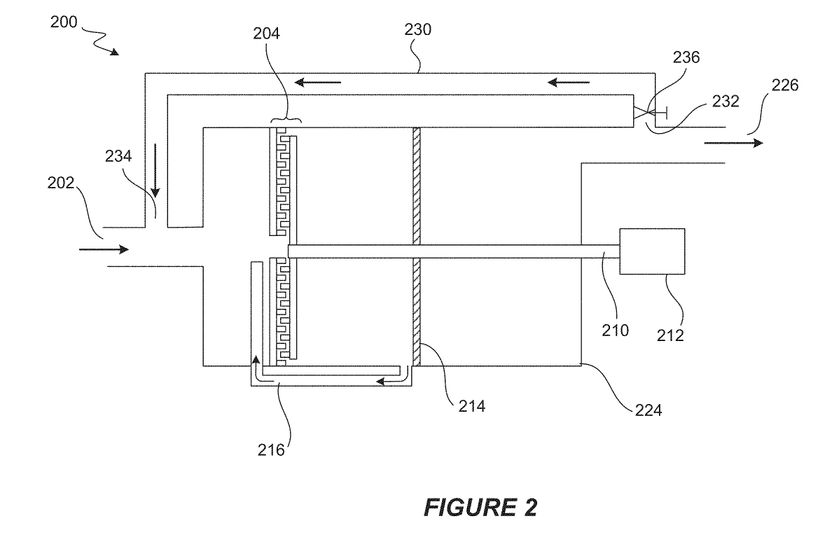

FIG. 2 shows a fluid treatment apparatus 200, according to another embodiment of the present arrangements and that includes additional components to recirculate a fluid and solids. Fluid treatment apparatus 200 includes a pulverizer 204, rotatable shaft 210, motor 212, restrictor or filter 214, first recirculating line 216, housing 224, housing inlet 202, and housing outlet 226 which are substantially similar to their counterparts in FIG. 1, i.e., pulverizer 104, rotatable shaft 110, motor 112, restrictor or filter 114, first recirculating line 116, housing 124, housing inlet 102, and housing outlet 126 of FIG. 1. Fluid treatment apparatus 200, however, incorporates a second recirculating line 230 that is different than first recirculating line 216. Second recirculating line 230, with a second recirculating line inlet 232 disposed downstream from restrictor or filter 214, is configured to receive all or a portion of the fluid and solid filtrate that passes through restrictor or filter 214.

During operation of fluid treatment apparatus 200, an incoming stream, which includes fluids and solids, flows into pulverizer 204. Downstream from pulverizer 204, first recirculating line 216 receives a portion of the fluid and solids—the fluid and solid residue—that does not pass through restrictor or filter. The fluid and solid residue is conveyed upstream from pulverizer 204 and mixed with the incoming fluid stream. The solid and fluid filtrate, which flows through restrictor or filter 204, may exit through housing outlet 226. However, in certain embodiments of the present arrangements, second recirculating line 230 may receive all or a portion of the solid and fluid filtrate through second recirculating line input 232. Second recirculating line outlet 230 conveys the fluid and solid filtrate to a location upstream of pulverizer 204. The fluid and solid filtrate mix with the incoming fluid stream from housing inlet 202 and the solid and fluid residue from first recirculating line 216, to create an admixed fluid stream. The admixed fluid stream is then conveyed to pulverizer 204.

Valve 236 may be adjusted to increase, decrease or stop fluid flow into second recirculating line 230. Preferably, valve 236 is used in conjunction with a monitoring apparatus to analyze the fluid and solid filtrate. If the monitoring apparatus determines solid filtrates have not met a predetermined threshold, the monitor may instruct the valve to open to allow the fluid and solid filtrate into second recirculating line 230. Conversely, if the solid filtrates have exceeded the predetermined threshold, the monitor may instruct the valve to reduce or stop recirculation in second recirculating line 230. The predetermined threshold may depend on the nature of fluid treatment and the pollutant to be treated. By way of example, in certain embodiments of the present arrangements, fluid treatment apparatus 100 may remove about 90% or more of a pollutant, e.g., perchlorate concentration reduced from about 1000 μg/L of fluid to about 100 μg/L of fluid.

Fluid treatment apparatus 200 may be used in applications where it is desirable to retreat to reduce a significant portion of the solid and filtrate in a high volume fluid flow. Second recirculating line 230, in addition to first recirculating line 216, increases the volume of recirculating fluid through fluid treatment apparatus 200. As a result, pulverizer 204 repulverizes and/or recavitates a greater volume of fluid and solids, which removes dissolved pollutants and/or polluting particles at a faster rate.

To this end, second recirculating line 230 may have an appropriate internal diameter that increases the volume of fluid recirculating in fluid treatment apparatus 200. In one embodiment, this internal diameter in the present arrangements is about 20 mm and about 100 mm. In a preferred embodiment, the internal diameter ranges from about 25 mm to about 50 mm. In a more preferred embodiment, this internal diameter ranges from about 40 mm to about 50 mm.

In certain fluid treatment applications of the present teachings, repeated pulverizing and cavitating of solids in a fluid flow is more important than recirculating large solid particles from the fluid flow. In one embodiment of present arrangements, fluid treatment apparatus 200 does not include restrictor or filter 216. Instead, fluid treatment apparatus 200 includes a disc shaped support structure having multiple apertures defined therein. By way of example, the disc may have defined thereon multiple apertures with a diameter ranging from about 10 mm to about 50 mm. A portion of large pulverized solid particles and fluid, forced outward by centrifugal force, may be conveyed into first recirculating line 216. However, the discapertures allow a significant portion of the pulverized fluid and solids to pass therethrough, which are then directed to a second recirculating loop 230 and/or housing outlet 226. In this configuration, the large volume of the fluid stream may be recirculated until the pollutant are removed or reach a desired threshold value.

In other embodiments of the present arrangements, a fluid treatment apparatus (e.g., fluid treatment apparatus 100 of FIG. 1 and fluid treatment apparatus 200 of FIG. 2) includes one or more solid inlets to introduce solids (e.g., adsorbents) to the fluid flow. In one preferred embodiment of the present arrangements, the solids inlet is coupled to a housing inlet (e.g., housing inlet 102 of FIG. 1 and housing inlet 202 of FIG. 2). Solids added through the solids inlet are mixed with incoming fluid flow, which contains fluid and solids, from the housing inlet. The solid inlet may also include a valve to regulate the amount of solids that are introduced into the fluid treatment apparatus.

In another embodiment of the present arrangements, one or more solids outlets remove solids (e.g., not dissolved solid contaminants and added solids (e.g., adsorbents)) from a fluid treatment apparatus 100. In one preferred embodiment, a first solids outlet in the present arrangements is positioned on a first recirculation line (e.g., first recirculation line 116 of FIG. 1 and first recirculation line 216 of FIG. 2). As solids are recirculated through the first recirculating line, some or all of the solids may be removed from the first solids outlet. In another embodiment, a second solids outlet is positioned on a second recirculation line (e.g., second recirculation line 230 of FIG. 2). First and second solids outlets may be coupled with a valve to direct some or all of the solids to first recirculating line outlet 120 or the first solids outlet.

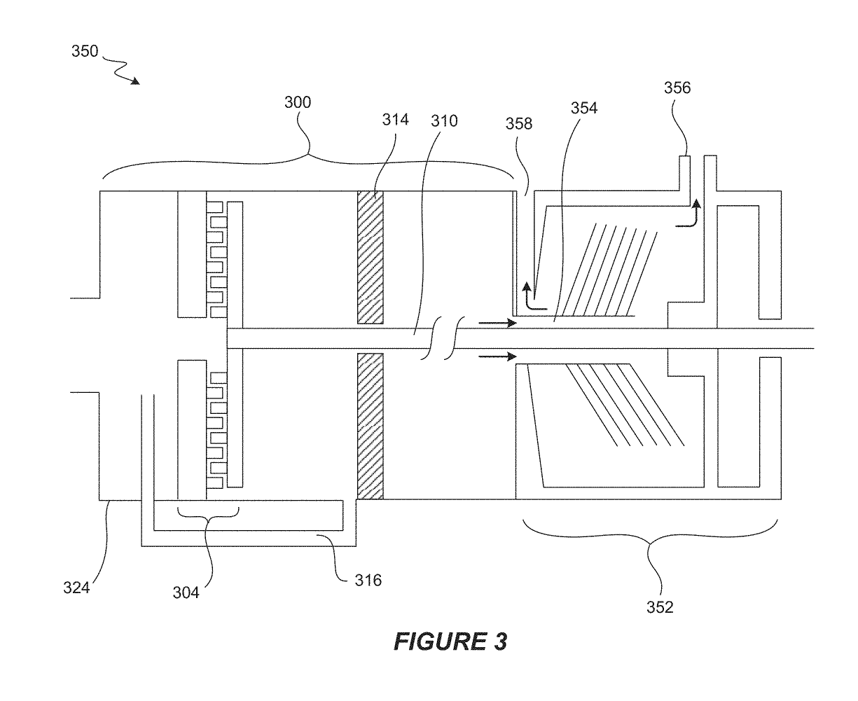

FIG. 3 shows a fluid treatment system 350, according to one embodiment of the present arrangements and that includes a fluid treatment apparatus 300. Fluid treatment apparatus 300 includes a pulverizer 304, rotatable shaft 310, restrictor or filter 314, recirculating line 316, and housing 324 which are substantially similar to their counterparts shown with respect to fluid treatment apparatus 100 in FIG. 1, i.e., pulverizer 104, rotatable shaft 110, restrictor or filter 114, first recirculating line 116, and housing 124. In certain embodiments, fluid treatment apparatus 300 may also include a second recirculating line (e.g., second recirculating line 230 of FIG. 2). Fluid treatment system 350 further includes a centrifugal separator 352, which is located downstream from fluid treatment apparatus 300 and separates solids from fluid. During an operative state of fluid treatment system 350, the residual solids and fluid are recirculated back to pulverizer 304 and filtrate solids and fluid pass through restrictor or filter 314. Centrifugal separator 352 through centrifugal inlet 354 receives the filtrate solids and fluid. In centrifugal separator 352, filtrate solids and fluid are spun at a high velocity along the same axis as rotatable shaft 310, which separates the filtrate solid from the filtrate fluid. Centrifugal separator 352 may be included and/or be coupled to rotatable shaft 310 or driven by an alternately rotatable means. The resultant solid matter is removed from centrifuge 352 at solids outlet 356 and the resultant fluid is removed from fluid outlet 358.

In another embodiment of the present arrangements, fluid treatment system 350 may use ultrasonic waves to generate acoustic cavitation in the fluid inside fluid treatment system 350. By way of example, one or more acoustic drivers may be disposed on or within housing 324 between restrictor or filter 314 and centrifugal separator 352. Acoustic waves, generated by the one or more acoustic drivers, penetrate the housing causing acoustic cavitation in the fluid. The placement of acoustic drivers, however, is not restricted to this location. Acoustic drivers may be positioned at an appropriate location in fluid treatment system 350 where the fluid may undergo effective cavitation.

In certain embodiments of the present arrangements, fluid treatment system 350, or components thereof, are pressurized to aid cavitation strength, aid flow through restrictor or filter 314 and/or reduce the size of any gas or vapor voids in the fluid, which may interfere with fluid flow. In one embodiment, fluid treatment apparatus 300 includes a gas injection port, upstream from pulverizer 304, to aid in cavitation, aid in removing species, and/or to kill organisms. According to another embodiment, fluid treatment apparatus 300 may include one or more baffles or vanes, upstream of restrictor or filter 314, to channel the fluid and pulverized solids to the center of restrictor or filter 314 and/or to force the fluid and pulverized solids radially outward. In yet another embodiment, fluid treatment system of the present arrangements may further comprise one or more members chosen from a group comprising settling tank, dead end filter, chromatographic separator, including ion-exchange chromatography, electrolytic separator, coagulation device, flocculation device and air flotation device.

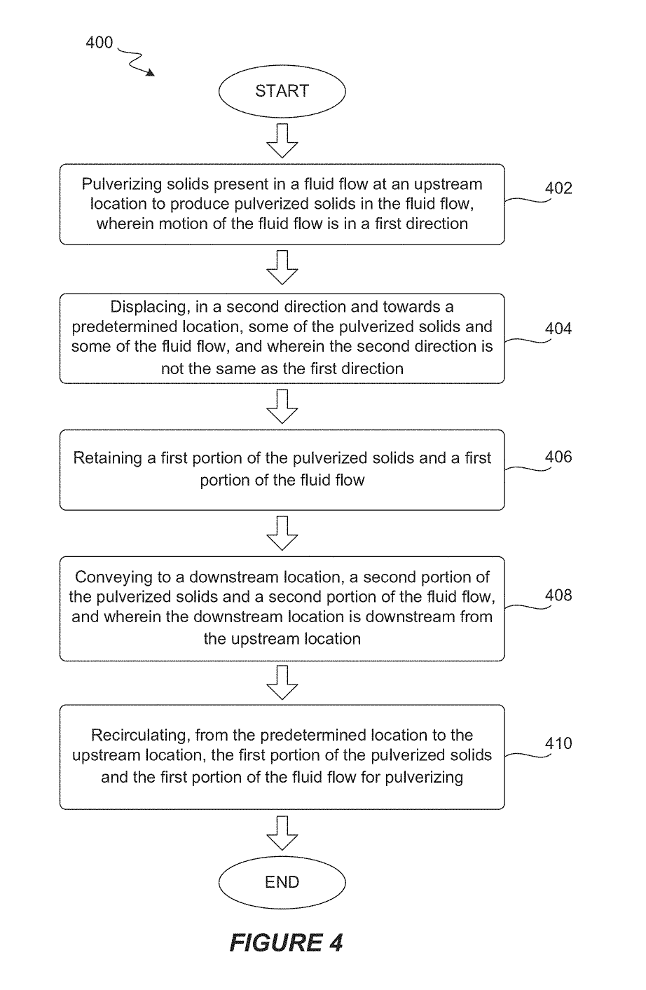

The present teachings also offer novel methods of treating a fluid. In one embodiment of the present teachings, fluid is treated using a fluid treatment apparatus (e.g., fluid treatment apparatus 100 of FIG. 1). FIG. 4 shows a method 400, according to one embodiment of the present teachings, for treating a fluid. Method 400 preferably begins with a step 402, which includes pulverizing solids present in a fluid flow at an upstream location (at or proximate to pulverizer 104 of FIG. 1) to produce pulverized solids in the fluid flow, wherein the motion of the fluid flow is in a first direction (e.g., an axial direction). Pulverizing is preferably carried out by a pulverizer (e.g., pulverizer 104 of FIG. 1). In one embodiment of the present teachings, the pulverizer includes a rotor (e.g., rotor 108 of FIG. 1) and a stator (e.g., stator 106 of FIG. 1), each having one or more pulverizing pins (e.g., pulverizing pins 122 of FIG. 1). In addition to pulverizing solids, the rotor and stator may affect cavitation in the mixture of pulverized solids and fluid.

Process 400 then proceeds to a step 404, which includes displacing, in a second direction and towards a predetermined location some of the pulverized solids and some of the fluid flow. In this step, the second direction (e.g., radial direction) is not the same as the first direction. In one embodiment of the present teachings, the second direction is at an angle (e.g., an angle that ranges from about 50° with respect to the first direction to about 90° with respect to the first direction). In one embodiment of the present teachings, spinning a rotatable shaft at a speed that ranges from about 50 rpms to about 50,000 rpms radially displaces residual solids and fluid.

A next step 406 includes retaining a first portion of the pulverized solids (also herein referred to as “solids residue”) and a first portion of the fluid flow (also herein referred to as “fluid residue”).

Next, a step 408 is carried out. Step 408 includes conveying to a downstream location, a second portion of the pulverized solids (also herein referred to as “filtrate solids”) and a second portion of the fluid flow (also herein referred to as “filtrate fluid”). In this step, the downstream location (e.g., a location that is downstream from restrictor and filter 114 of FIG. 1) is downstream from the upstream location (at or proximate to pulverizer 104 of FIG. 1). In this embodiment, filtrate solids and fluid are the portions of the pulverized solids and the fluid that did not radially displace to a predetermined location (e.g., at or near first recirculation inlet 118 of FIG. 1). In certain embodiments, filtrate solids have an average size that ranges from about 1 μm to about 10 mm.

A next step 408 includes recirculating, from the predetermined location to the upstream location, the first portion of the pulverized solids and the first portion of the fluid flow for pulverizing. In one embodiment of the present teachings, residual solids and fluid are recirculated through a first recirculating line (e.g., first recirculating line 116 of FIG. 1) to a location upstream of the pulverizer. These residual solids and fluid are mixed with an incoming stream of mixture of solids and fluid and then undergo pulverizing again. In certain embodiments, fluid treatment process 400 is automated, to ensure maximize solids pulverization, increase restriction or filtration and ensure optimal energy efficiency.

In one embodiment of the present teachings, process 400 further includes an additional step of recirculating filtrate solids and fluids, from a location downstream from the restrictor or filter to a location prior to the pulverizer. By way of example, the filtrate solids and fluids are recirculated through a second recirculating line (e.g., second recirculating line 230 of FIG. 2) to a location upstream of the pulverizer. The filtrate solids and fluids are mixed with the incoming stream of solids and fluids and the residual solids and fluids from the first recirculating line and then undergo pulverization again.

In another embodiment of the present teachings, process 400 further includes an additional step of effecting fine solids separation, in which some portion of the solids filtrate are separated from some portion of the fluid filtrate. By way of example, a centrifugal separator (e.g., centrifugal separator 352 of FIG. 3) may be used to effect fine solid separation of solids filtrate from fluid filtrate.

Fluid treatment process 400 provides a more efficient process of treating fluid. In conventional treatment processes, the entire fluid volume or input stream is recirculated to remove solids from the fluid. In sharp contrast, fluid treatment processes of the present teachings (e.g., fluid treatment processes 400 of FIG. 4), however, do not need to recirculate the entire fluid volume or input stream. Rather, preferably a portion of the fluid volume or input stream is recirculated, thereby reducing the input energy required to operate the treatment system. Furthermore, fluid treatment process 400 allows for selectively removing or filtering pulverized solids of a predetermined size from the fluid.

The present teachings contemplate other embodiments of processes for treating a fluid. In one embodiment of the present teachings, the process of treating a fluid includes adding or removing solids to the fluid before pumping the fluid into the fluid treatment apparatus. Adding or removing solids to the fluid may affect the intensity of the cavitation within the fluid and/or the efficiency of the decontamination or adsorption process. It is noteworthy that a pulverizer is not necessary to pulverize solids and in the absence of the pulverizer, fluid treatment process 400 may employ certain cavitation apparatus to effectively pulverize the solids.

In another embodiment of the present teachings, inducing cavitation in a fluid includes use of an additive, such as an adsorbent in the cavitation systems and processes. Adsorption may be used to remove the organic or inorganic pollutants in the fluid. Examples of adsorbents include activated carbon, clay, soil, bituminous coal, montmorillonite, chitosan, fly ash, alumina, bentonite, zeolite, β-cyclodextrin, dead mushrooms, silica gel, diatomaceous earth, Amberlite by Dow Chemical Company of Midland, Mich., ion exchange resins, various synthetic polymers such as SP206 (a polystyrene matrix cross-linked with divinyl benzene), and polyethylene (terephthalate). One role of cavitation is to increase the surface area of the added adsorbents so that more surface area of the adsorbent is available per unit mass of adsorbent. Accordingly, cavitation as proposed by the present teachings may break down big millimeter-sized particles into small micron sized or even nano-sized particles, creating a large surface area for adsorption. The present teachings recognize that cavitation may assist adsorption in at least three ways: (1) increase in mass transfer coefficient; (2) increasing the surface area; and (3) chemical modification of adsorption sites as well as pollutant molecules.

In one embodiment of the present teachings, a device is provided which has hydrodynamic cavitation as well as an additive. The additive may have a dual role. The additive may act as a cavitation enhancer providing more nuclei for cavitation inception. The additive may also act as an adsorbent, an adsorptive material capable of adsorption. Thus, the adsorbent may help a cavitation phenomenon and the cavitation helps the adsorption phenomenon. There may be a synergy between the cavitation phenomenon and the adsorption phenomenon.

As the fluid passes through the above-described pulverizer (e.g., pulverizer 104 of FIG. 1 and pulverizer 204 of FIG. 2) cavitation may be induced in the fluid and solids mixture. The rotor (e.g., rotor 108) and stator (e.g., stator 106) of the pulverizer each may have cavitating features (e.g., pins 122). As the fluid and solids mixture pass by the cavitation inducing features of the stationary stator at a high velocity, the pressure in the fluid reduces near the cavitation inducing features according to their design or location. Similarly, as the fluid and solids mixture pass by the cavitation inducing features of the rotating rotor at a high velocity, the pressure in the fluid reduces near the cavitation inducing features. This reduction in pressure may cause some of the fluid to evaporate and cavitation bubbles to form which eventually grow further downstream and collapse as they reach towards the end zone of the cavitation inducing features due to an increase in the pressure of the fluid by pressure recovery. This phenomenon of formation, growth and subsequent collapse of gas/vapor bubbles is called cavitation. The cavitation bubbles generally collapse so fast (e.g., bubble wall speed can be faster than the speed of sound in the fluid) that the contents of the bubble may not have enough time to escape through the interfacial boundary of the bubble by diffusion. Hence, the contents of the bubbles may get compressed adiabatically, which causes a tremendous increase in temperature and pressure inside the bubble. At such high local temperatures inside the imploding cavitation bubbles, the relatively weak interatomic bonds in the gas/vapor molecules may get disrupted. While wishing to not be bound by theory, the present teachings recognize that this thermal dissociation or breakage of molecules may give rise to oxidative species like HO, HO₂, O radicals and peroxy compounds such as H₂O₂ and O₃ inside and in the interfacial region of the bubble. These short-lived species are thrown out of the bubble upon collapse and they may then react with particles and solute molecules, e.g., the organic compounds in the fluid at the outer shell of the bubble.

Synergized effect of highly oxidative species with high local temperatures may cause the organic molecule to undergo oxidative degradation. The volatile organic chemical compounds such as halomethanes, for example, chloroform, carbon tetrachloride and trichloroethane, may evaporate during cavitation bubble formation and enter the cavitation bubbles. These compounds may then be exposed to the high temperatures inside the bubble and decompose into less hazardous compounds by pyrolysis or combustion reaction. Thus, according to the present teachings, each cavitation bubble may be thought of as acting as a microreactor or a microincinerator for these volatile organic hazardous chemical compounds. The non-volatile organic hazardous chemical compounds, such as phenols, chloro-phenols, nitro-phenols and parathion, however, may not enter the cavitation bubbles due to their lower vapor pressure and remain near the interface of the cavitation bubbles and surrounding fluid. The present teachings believe that they may be attacked and mineralized into lesser hazardous chemical intermediates and end products by the various oxidizing radical species, such as the hydroxyl radicals, formed by the decomposition of water vapor inside the cavitation bubbles and may be thrown out during the implosive collapse. These radicals may be highly reactive and are capable of oxidizing almost all contaminants in water. Such oxidation may be represented by following reactions:
H₂O→OH°+H°
OH°+OH°→H₂O₂
OH°+OH°→H₂O+O
OH°+OH⁻→H2+O₂
H°+O₂→HO°₂
HO°₂+H°→H₂O₂
HO°₂+HO°₂→H₂O₂+O₂
OH°+H₂O →H₂O₂+O°
H₂O+O°→H₂O₂
H°+H°→H₂
H°+OH°→H₂O
Aqueous pollutants+oxidizing species →degraded products

In the above-mentioned reactions, the representation of X°refers to a free radical of X, where X is H, OH and HO₂.

In this manner, enhanced cavitation achieved from multi-stage cavitation processes and systems of the present teachings are useful for, among other things, treating various types of fluid streams.

### EXAMPLES

The Applicant presents the following experimental results to illustrate the removal of a dissolved pollutant, perchlorate, from water using the systems and methods described herein. For each test, the fluid treatment system is a closed system, where fluid flow exiting the fluid treatment apparatus is conveyed back to the input. An additive, 0.1% wt/vol (0.1 gram per 100 ml of polluted water) of granular lignite, was added to the water to be treated. And a pulverizer (e.g., pulverizer 104 of FIG. 1) rotated at a rotational speed ranging from about 2,200 rpms to about 2,500 rpms. The water flow rate into the fluid treatment apparatus was set at about 50 g/min. In each experiment, various components within a fluid treatment apparatus (e.g., fluid treatment apparatus 100 of FIG. 1 or fluid treatment apparatus 200 of FIG. 2) were added or removed to illustrate the varying effectiveness of the fluid treatment apparatus.

In a first experiment, the fluid treatment apparatus included a pulverizer, but did not include a restrictor or filter (e.g., restrictor or filter 114 of FIG. 1), a first recirculating line (e.g., first recirculating line 116 of FIG. 1) or a second recirculating line (e.g., second recirculating line 230 of FIG. 2). After 2 minutes of continuous operation, the fluid treatment apparatus measured 15.38% (removal of perchlorate in weight % per liter of fluid flow). In this experiment, the perchlorate concentration in the fluid went down from 1300 microgram of perchlorate/liter of polluted water to 1100 microgram of perchlorate/liter of polluted water.

For a second experiment, the fluid treatment apparatus includes a pulverizer and a first recirculating line with an internal diameter of about 19 mm and a restrictor or filter having a particle restriction size ranging from about 6 mm to about 12 mm. After 2 minutes of continuous operation, the fluid treatment apparatus measured a 28.57% removal of perchlorate in weight % per liter of the fluid stream.

In a third experiment, the fluid treatment apparatus included a pulverizier, a first recirculating line with an internal diameter of about 19 mm, a second recirculating line with an internal diameter of about 50 mm. Instead of a filter, the fluid treatment apparatus of this experiment included a disc having defined therein multiple apertures have a diameter of about 6 mm. The disc did not filter or restrict the fluid flow through the fluid treatment apparatus. However, due to the differential centrifugal forces acting on smaller and bigger solids in the rotating fluid downstream of the pulverizer, a portion of bigger solid particles are thrown out towards the sidewall of the housing and collected by the first recirculating line and immediately recycled back to the pulverizer for further fine pulverizing. After 2 minutes of continuous operation, the fluid treatment apparatus measured a 55.33% removal of perchlorate in weight % per liter of the fluid stream. After 4 minutes the fluid treatment apparatus removed 62% of the perchlorate and 65.33% perchlorate removal in 10 minutes.

While the fluid treatment apparatus and processes related thereto discuss treatment of fluid, the present arrangements and teachings may be used to treat any fluid. Furthermore, although the mixture is described in terms of a fluid and solids, the present teachings recognize that a wide variety of mixtures may be treated. Mixtures that are effectively treated using apparatuses and methods of the present teaching include pure fluids, mixture of one or more fluids, one or more different types of solids admixed with one or more different types of fluids. In addition, the apparatuses and methods of the present teaching may be used to treat a mixture that includes non-solids (e.g., gels).

Although illustrative embodiments of this invention have been shown and described, other modifications, changes, and substitutions are intended. Accordingly, it is appropriate that the disclosure be construed broadly and in a manner consistent with the scope of the disclosure, as set forth in the following claims.

What is claimed is:

1. A fluid treatment apparatus comprising:
a pulverizer designed to pulverize solids present in a fluid flow to produce pulverized solids admixed with said fluid flow;
a rotatable shaft for rotating said pulverized solids and said fluid flow;
a restrictor or filter for retaining a first portion of said pulverized solids, and allowing a second portion of pulverized solids and a second portion of said fluid flow to pass therethrough; and
a first recirculating line configured to receive said first portion of said pulverized solids and a first portion of said fluid flow that did not pass through said restrictor or said filter.

2. The fluid treatment apparatus of claim 1, wherein said first recirculating line further comprises a first recirculating line inlet and a first recirculating line outlet, and wherein said first recirculating line inlet is located upstream from said restrictor or said filter and said first recirculating line outlet is located upstream from said pulverizer.

3. The fluid treatment apparatus of claim 2, further comprising a housing for enclosing said pulverizer, said rotatable shaft and said restrictor or said filter, and said first circulating line inlet is an aperture defined in said housing.

4. The fluid treatment apparatus of claim 3, wherein said first recirculating line outlet extends into said housing and is located proximate said pulverizer.

5. The fluid treatment apparatus of claim 1, further comprising a housing that is designed to be coupled to or for housing said first recirculating line.

6. The fluid treatment apparatus of claim 1, said pulverizer includes a cavitation apparatus that effects cavitation.

7. The fluid treatment apparatus of claim 6, wherein said cavitation apparatus includes a rotor and a stator that act on said mixture to pulverize said solids and effect cavitation.

8. The fluid treatment apparatus of claim 7, wherein said restrictor or said filter is stationary or rotates.

9. The fluid treatment apparatus of claim 7, wherein said restrictor or said filter rotates in a same direction as a rotational direction of said rotor or rotates in an opposite direction of said rotation direction of said rotor.

10. The fluid treatment apparatus of claim 1, wherein said fluid flow towards said pulverizer is in an axial direction such that an axis of said axial direction extends along a length of said fluid treatment apparatus, and wherein said rotatable shaft is capable of rotating around said axis to redirect motion of some of said fluid flow and some of said pulverized solids in a radial direction that is at an angle from said axial direction.

11. The fluid treatment apparatus of claim 10, wherein some of said pulverized solids redirected in said radial direction have an average particle size that is greater than that of said second portion of said pulverized solids that pass through said restrictor or said filter.

12. The fluid treatment apparatus of claim 1, wherein said restrictor or said filter is cone-shaped and an apex of the cone points towards said pulverizer.

13. The fluid treatment apparatus of claim 1, wherein said second portion of said pulverized solids have an average diameter that ranges from about 1 μm to about 10 mm.

14. The fluid treatment apparatus of claim 1, further comprising a second recirculating line configured to receive a portion of said second portion of pulverized solids and a portion of said second portion of said fluid flow.

15. The fluid treatment apparatus of claim 14, wherein said second recirculating line further comprises a second recirculating line inlet and a second recirculating line outlet, and wherein said second recirculating line inlet is located downstream from said restrictor or said filter and said second recirculating line outlet is located upstream from said pulverizer.

16. A fluid treatment system comprising:
a fluid treatment apparatus for receiving a fluid flow and then pulverizing and filtering a portion of solids present in said fluid flow to provide a solid filtrate and a fluid filtrate; and
a separator for separating said solid filtrate from said fluid filtrate to produce a treated fluid.

17. The fluid treatment system of claim 16, wherein said separator includes at least one member chosen from a group comprising centrifuge, ultrasonic cleaner, settling tank, magnetic separator, dead-end filter, chromatographic separator including ion-exchange chromatography, venturi, acoustic driver, gas injection port, electrolytic separator, coagulator, flocculation device and air flotation device.

18. A fluid treatment method comprising:
Pulverizing solids present in a fluid flow at an upstream location to produce pulverized solids in said fluid flow, wherein motion of said fluid flow is in a first direction;
displacing, in a second direction and towards a predetermined location, some of said pulverized solids and some of said fluid flow, and wherein said second direction is not the same as the first direction;
retaining a first portion of said pulverized solids and a first portion of said fluid flow;
conveying to a downstream location, a second portion of said pulverized solids and a second portion of said fluid flow, and wherein said downstream location is downstream from said upstream location; and
recirculating, from said predetermined location to said upstream location, said first portion of said pulverized solids and said first portion of said fluid flow for pulverizing.

19. The fluid treatment method of claim 18, further comprising mixing said first portion of said pulverized solids and said first portion of said fluid flow with an incoming fluid flow that includes incoming solids.

20. The fluid treatment method of claim 18, wherein said pulverizing includes performing acoustic cavitation or performing hydrodynamic cavitation.

21. The fluid treatment method of claim 18, wherein said upstream location is a location prior to a pulverizer, wherein said predetermined location is at or proximate a recirculating line inlet that receives said first portion of said pulverized solids and said first portion of said fluid flow, and wherein said downstream location is located downstream from a filter or a restrictor.

22. The fluid treatment method of claim 18, further introducing an adsorbent to remove dissolved solids from said fluid flow by adsorption.

23. The fluid treatment method of claim 20, wherein said adsorbent is a material chosen from a group comprising carbon, clay, soil, bituminous coal, montmorillonite, chitosan, fly ash, alumina, bentonite, zeolite, β-cyclodextrin, dead mushrooms, silica gel, diatomaceous earth, ion exchange resin, SP206, and polyethylene.
